(19) United States
(12) Patent Application Publication
(10) Pub. No.: US 2022/0371650 A1
(43) Pub. Date: Nov. 24, 2022

(54) ELECTRIC POWER STEERING APPARATUS

(71) Applicant: MANDO CORPORATION, Pyeongtaek-si (KR)

(72) Inventor: Hyunsik HAN, Suwon-si (KR)

(73) Assignee: MANDO CORPORATION, Pyeongtaek-si (KR)

(21) Appl. No.: 17/747,252

(22) Filed: May 18, 2022

(30) Foreign Application Priority Data
May 24, 2021 (KR) 10-2021-0066370

(51) Int. Cl. B62D 3/12; B62D 5/04

(52) U.S. Cl. CPC B62D 3/126; B62D 5/0403

(57) ABSTRACT

The present disclosure relates to an electric power steering apparatus including a rack housing extending in length along a lateral direction of a vehicle and opened by a hollow formed along its longitudinal direction to wrap a rack bar with both ends connected to tires, respectively, bellows connected to both ends of the rack housing, respectively, and formed to be flexibly stretched or contracted in an axial direction, a steel band provided to surround an end of the bellows connected to the rack housing to fix a connection of the rack housing and the bellows, and a coupler provided at the both ends of the rack housing and the end of the bellows and configured to couple the rack housing and the bellows so that, when the rack housing and the bellows are connected, the bellows is not separated from the rack housing and maintained connected thereto.

### CROSS-REFERENCE TO RELATED APPLICATIONS

This application claims benefit and priority to Korean Patent Application No. 10-2021-0066370, filed on May 24, 2021, with the Korean Intellectual Property Office, the disclosure of which is incorporated herein in its entirety by reference.

### BACKGROUND OF THE DISCLOSURE

### Field of the disclosure

The present disclosure relates to an electric power steering apparatus, and more particularly, to an electric power steering apparatus capable of improving assembly of a rack housing and a bellows and reducing costs.

### Related Art

In general, a steering system for a vehicle includes a steering wheel provided in a driver's seat, a steering shaft provided under the steering wheel, and a gearbox connected to the steering shaft to decelerate rotational force while changing the direction of power transmission.

Meanwhile, a rack bar extending to the left and right sides of the rack housing and connected to the steering shaft to operate in the axial direction is installed inside the rack housing which is provided in a hollow to form the outer shape of the gear box.

Further, a pair of tie rods are installed at opposite ends of the rack bar to be interlocked therewith, and are connected to the tire wheel sides of opposite sides of the vehicle, and bellows are installed outside the tie rods and the rack bar that are interlocked in the axial direction.

FIG. 1 is a partial perspective view illustrating a structure in which a rack housing 2 and a bellows 4 are coupled according to a related art.

Referring to FIG. 1, in the related art, an O-ring 3 which is a sealing member is provided on an outer surface of an end of the rack housing 2. The end of the rack housing 2 is inserted into the bellows 4 at a predetermined depth along the axial direction, and the rack housing 2 and the bellows 4 are coupled.

When the rack housing 2 and the bellows 4 are coupled in this way, an outer surface of an end of the bellows 4 is wrapped with a steel band 5 to fix the rack housing 2 and the bellows 4.

As described above, in the related art, the rack housing 2 and the bellows 4 were press-fitted. However, this method has an issue in that it is not easy to maintain the connection relationship between the rack housing 2 and the bellows 4.

As described above, since the rack housing 2 and the bellows 4 were press-fitted, the structure was not capable of maintaining the connection state between the rack housing 2 and the bellows 4, except by the steel band 5.

In other words, in an unavoidable situation where the steel band 5 is separated, the connected state between the rack housing 2 and the bellows 4 was not easily fixed, and the rack housing 2 and the bellows 4 were separated.

### SUMMARY

Example embodiments provide an electric power steering apparatus capable of improving assembly of a rack housing and a bellows as well as reducing costs.

According to an example embodiment, there is provided an electric power steering apparatus including a rack housing extending in length along a lateral direction of a vehicle and opened by a hollow formed along its longitudinal direction to wrap a rack bar with both ends connected to tires, respectively, bellows connected to both ends of the rack housing, respectively, and formed to be flexibly stretched or contracted in an axial direction, a steel band provided to surround an end of the bellows connected to the rack housing to fix a connection of the rack housing and the bellows, and a coupler provided at the both ends of the rack housing and the end of the bellows and configured to couple the rack housing and the bellows so that, when the rack housing and the bellows are connected, the bellows is not separated from the rack housing and maintained connected thereto.

Further, the coupler may include a coupling groove concavely formed along a radial direction on an outer peripheral surface of an end of the rack housing, and a protrusion member provided inside the end of the bellows and having a coupling protrusion inserted into the coupling groove to slide along the coupling groove.

Further, one coupling groove may be provided or a plurality of the coupling grooves may be provided to be spaced apart by a predetermined angle along a circumferential direction of the rack housing, and when the plurality of coupling grooves are provided, a plurality of the coupling protrusions may be provided to correspond to the plurality of coupling grooves.

Further, the coupling groove may include a first groove rod formed to extend from the end of the rack housing in a direction parallel to an axial direction of the rack housing, and a second groove rod formed to extend from an end of the first groove rod in a circumferential direction of the rack housing.

Further, the coupling groove may further include a third groove rod extending from an end of the second groove rod in a direction parallel to the first groove rod toward the end of the rack housing, and formed to be shorter than a length of the first groove rod.

Further, the coupling groove may further include an escape prevention protrusion formed on an inner surface of the second groove rod at a position spaced apart by a predetermined distance from an end of the second groove rod in a direction toward the first groove rod to prevent the coupling protrusion inserted to the end of the second groove rod form escaping.

Further, the protrusion member may include a ring band having one surface in close contact with the inner surface of the end of the bellows, and formed in a circular ring shape so that the bellows communicates with the rack housing.

Further, one coupling protrusions may be provided or a plurality of the coupling protrusions may be provided to be spaced apart by a predetermined angle along a circumferential direction on an inner surface of the ring band.

Other specific details of example embodiments are included in the detailed description and appended drawings.

An electric power steering apparatus according to example embodiments has following effects.

First, by providing a coupler including a coupling groove and a protrusion member, a connection state between the rack housing and the bellows may be firmly maintained even before being fixed with a steel band. In particular, as the number of the coupling grooves and the protrusion members increases, the connection state between the rack housing and the bellows may be more firmly maintained.

Second, even if the steel band is inevitably separated from the bellows, it is possible to prevent the rack housing and the bellows from being easily separated from each other as well as improve the stability of the vehicle because the rack housing and the bellows are firmly connected by the coupler.

Third, since the rack housing and the bellows may be connected only by inserting a coupling protrusion into a coupling groove and sliding it along the coupling groove, it is possible to couple the rack housing and the bellows more easily compared to the press-fit method and improve assemblability.

### BRIEF DESCRIPTION OF THE DRAWINGS

FIG. 1 is a partial perspective view illustrating a coupling structure of a rack housing and a bellows of an electric power steering apparatus according to a related art.

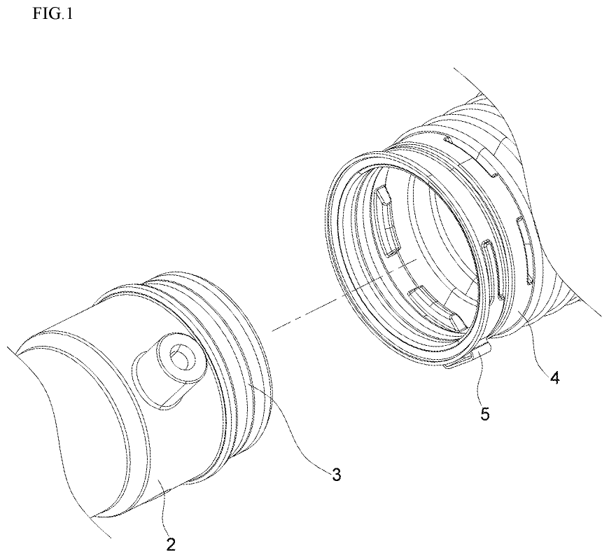

FIG. 2 is a partial perspective view illustrating a coupling state of a rack housing and a bellows of an electric power steering apparatus according to an example embodiment.

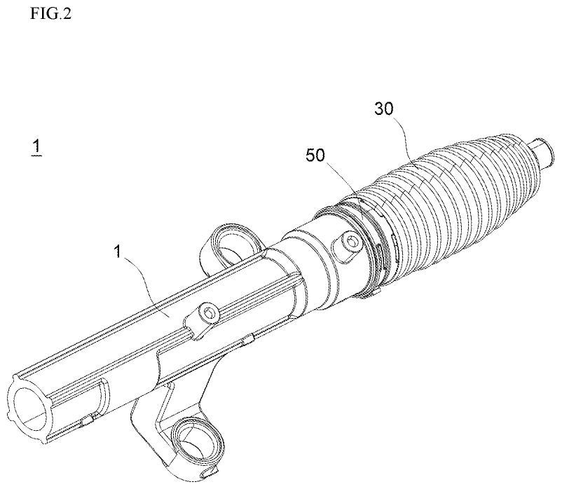

FIG. 3 is a partially exploded perspective view illustrating a coupling structure of the rack housing and the bellows according to FIG. 2.

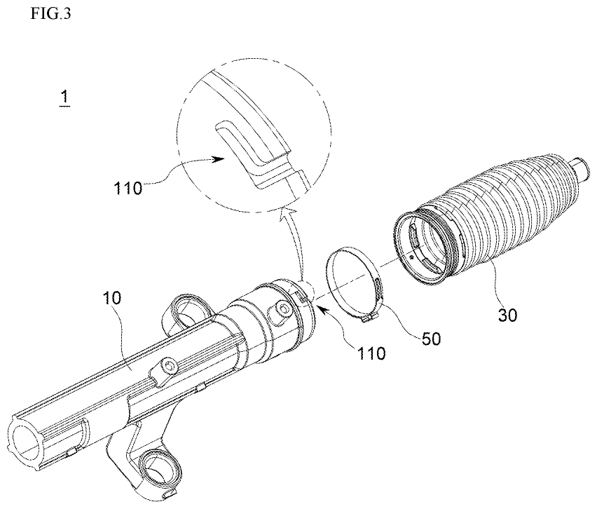

FIG. 4 is a partial perspective view illustrating a detailed structure of a coupling groove according to an example embodiment.

FIG. 5 is a partial perspective view illustrating a detailed structure of a protrusion member according to an example embodiment.

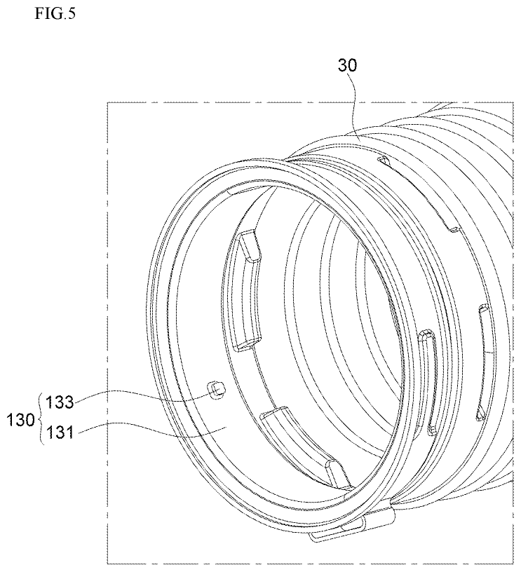

FIG. 6 is a flowchart illustrating a coupling process of a rack housing and a bellows according to an example embodiment.

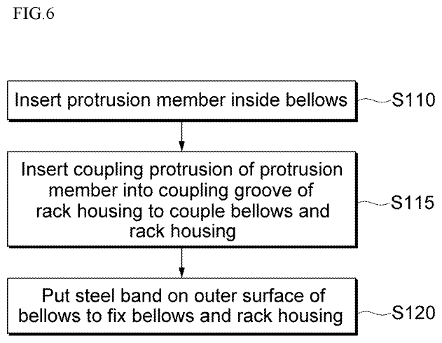

FIG. 7 is a partial perspective view illustrating a detailed structure of a coupling groove according to another example embodiment.

FIG. 8 is a diagram illustrating a detailed structure of a coupling groove according to still another example embodiment.

### DESCRIPTION OF EXEMPLARY EMBODIMENTS

Example embodiments will be described in detail so that those skilled in the art can easily make them with reference to the accompanying drawings. The present disclosure may be implemented in various different ways and is not limited to the example embodiments.

It should be noted that the drawings are schematic and not drawn to scale. Relative dimensions and ratios of parts in the drawings have been exaggerated or reduced in size for clarity and convenience in the drawings and any dimensions are merely exemplary and not limiting. Further, the same structures or components illustrated in two or more different drawings are denoted by the same reference numeral to represent similar features.

Example embodiments specifically illustrate ideal embodiments of the disclosure. As a result, various modifications of the diagrams are expected. Accordingly, example embodiments are not limited to specific forms of the illustrated scope, and include, for example, a modification of shape by manufacturing.

An electric power steering apparatus 1 according to an example embodiment includes a rack housing 10, a bellows 30, a steel band 50, and a coupler 100.

The rack housing 10 is provided to wrap a rack bar (not shown in the drawings). The rack bar (not shown in the drawings) extends in length in a lateral direction of a vehicle (not shown in the drawing) and tires (not shown in the drawings) are connected to both ends of the rack bar, respectively.

Both ends of the rack housing 10 are opened by a hollow formed along its longitudinal direction to surround the rack bar (not shown in the drawings).

The bellows 30 are respectively connected to both ends of the rack housing 10. The bellows 30 is formed in a shape in which wrinkles are repeated so as to be flexibly stretched or contracted in an axial direction of the rack housing 10. Although specifically not shown in the drawings, the bellows 30 has one end connected to the rack housing 10 and the other end coupled to the outside of a tie rod (not shown in the drawings) moving along the axial direction, thereby sealing the space between the rack housing 10 and the tie rod (not shown in the drawings) to maintain airtightness.

The steel band 50 is provided to surround an outer peripheral surface of an end of the bellows 30. Specifically, when the bellows 30 is connected to the rack housing 10, the steel band 50 surrounds the outer peripheral surface of the end of the bellows 30 to fix the connection between the rack housing 10 and the bellows 30.

Before fixing the rack housing 10 and the bellows 30 with the steel band 50, it is necessary to maintain connection between the rack housing 10 and the bellows 30.

In order to maintain the connection between the rack housing 10 and the bellows 30, coupling must be made in the process in which the rack housing 10 and the bellows 30 are connected before fixing the rack housing 10 and the bellows 30 with the steel band 50.

The coupler 100 is provided to couple the rack housing 10 and the bellows 30 as described above.

The coupler 100 is respectively provided at opposite ends of the rack housing 10 and at the ends of the bellows 30. When the rack housing 10 and the bellows 30 are connected, the coupler 100 prevents the bellows 30 from being separated from the rack housing 10 and maintains the connected state.

Specifically, the coupler 100 includes a coupling groove 110 and a protrusion member 130. The coupling groove 110 is formed on an outer peripheral surface of an end of the rack housing 10, and is formed concavely along a radial direction of the rack housing 10.

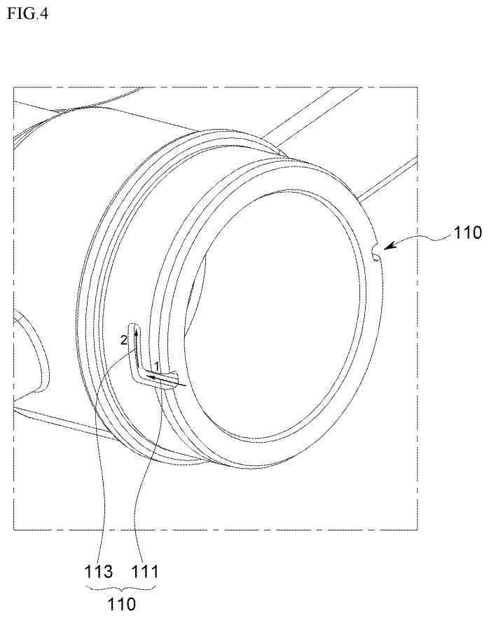

One coupling groove 110 is provided on the outer peripheral surface of the end of the rack housing 10 or a plurality of coupling grooves 110 are provided to be spaced apart by a predetermined angle along a circumferential direction on the outer peripheral surface. In the present example embodiment, referring to FIG. 4, two coupling grooves 110 are provided.

In the present example embodiment, the coupling grooves 110 are formed at positions symmetrical to each other with respect to the central axis of the rack housing 10. However, since the present disclosure is not limited thereto, three or more coupling grooves 110 may be formed to be spaced apart by a predetermined angle along the circumferential direction of the rack housing 10. As the number of the coupling grooves 110 increases, an effect of maintaining a robust connection between the rack housing 10 and the bellows 30 may be obtained.

Referring to FIG. 4 for more details of the shape of the coupling groove 110, the coupling groove 110 includes a first groove rod 111 and a second groove rod 113. The first groove rod 111 is formed to extend from the end of the rack housing 10 by a predetermined length in a direction parallel to the axial direction of the rack housing 10.

The second groove rod 113 is formed to extend from an end of the first groove rod 111 by a predetermined length along the circumferential direction of the rack housing 10. Further, in the present example embodiment, since two coupling grooves 110 are formed, the direction in which the second groove rod 113 extends in each of the coupling grooves 110 is identical.

For example, if the second groove rod 113 is formed to extend in a clockwise direction in one of the coupling grooves 110, the second groove rod 113 is also formed to extend in the clockwise direction in the other coupling groove 110. Only in the case of being formed in this way, the coupling protrusions 133 may move in the same way when the coupling protrusions 133 are inserted into the coupling grooves 110 and slide along the coupling grooves 110.

The protrusion member 130 is provided inside an end of the bellows 30. The protrusion member 130 has a coupling protrusion 133 inserted into the coupling groove 110 so as to slide along the coupling groove 110.

More particularly, the protrusion member 130 includes a ring band 131. The ring band 131 is provided on an inner surface of the end of the bellows 30, and one surface of the ring band 131 is provided in close contact with the inner surface of the end of the bellows 30.

The coupling protrusion 133 is formed on the other surface of the ring band 131, which is a surface that is not in close contact with the inner surface of the end of the bellows 30. In the present example embodiment, since two coupling grooves 110 are formed, two coupling protrusions 133 symmetrical with respect to the axial direction of the bellows 30 are formed to correspond to the coupling groove 110.

Further, the ring band 131 is formed in a circular shape so that the rack housing 10 may communicate with the bellows 30. The ring band 131 is formed of a metal material, and has elasticity so that it may be restored after being deformed by an external force. Therefore, when an operator temporarily deforms the ring band 131 by applying an external force and inserts it inside the end of the bellows 30 at the same time as removing the external force applied by the operator, the ring band 131 is restored to its original shape while being provided inside the end of the bellows 30.

A process in which the rack housing 10 and the bellows 30 are coupled/fixed in the electric power steering apparatus including the coupler 100 as described above will be described as follows.

First, the protrusion member 130 is inserted into the bellows 30 before connecting the rack housing 10 and the bellows 30 (S110). As described above, after the operator applies the external force to the ring band 131 to deform the ring band 131, the ring band 131 is inserted inside the end of the bellows 30.

When the external force applied to the ring band 131 is removed, the ring band 131 is restored to its original state and is provided inside the end of the bellows 131.

Next, while the coupling protrusion 133 of the protrusion member 130 is inserted into the coupling groove 110 of the rack housing 10, the rack housing 10 and the bellows 30 are coupled (S115).

When the bellows 30 is coupled to the rack housing 10, the coupling protrusion 133 of the protrusion member 130 first moves in a first direction parallel to the axial direction of the rack housing 10 along the first groove rod 111 of the coupling groove 110 (see FIG. 4).

When the coupling protrusion 133 reaches the end of the first groove rod 111, the bellows 30 is rotated clockwise or counterclockwise so that the coupling protrusion 133 moves in a second direction along the second groove rod 113 (see FIG. 4).

Thus, when the bellows 30 and the rack housing 10 are coupled, the bellows 30 and the rack housing 10 maintain the connected state by the coupler 100.

When the connected state between the rack housing 10 and the bellows 30 is maintained in this way, the steel band 50 is put on the outer surface of the bellows 30 to fix the connection state between the bellows 30 and the rack housing 10 (S120).

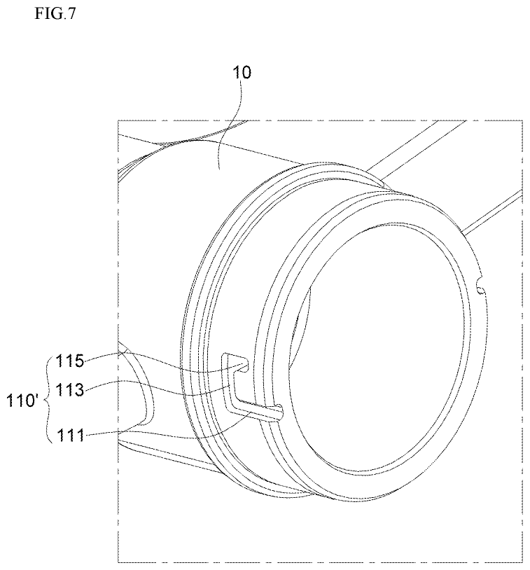

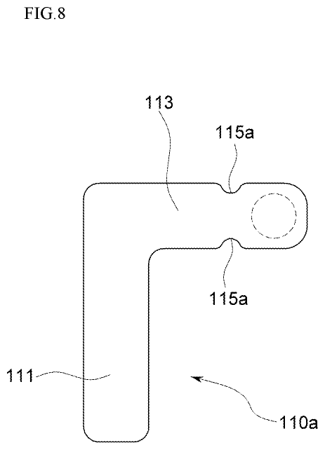

Meanwhile, other example embodiments of the coupling groove are shown in FIG. 7 and FIG. 8.

The coupling groove 110′ of another example embodiment shown in FIG. 7 includes the first groove rod 111 and the second groove rod 113 as in the above-described embodiment, and further includes a third groove rod 115.

The third groove rod 115 is further extended from an end of the second groove rod 113. The third groove rod 115 is extended from the end of the second groove rod 113 in a direction parallel to the first groove rod 111. In this case, the third groove rod 115 should be extended toward a starting direction of the first groove rod 111.

In other words, the third groove rod 115 further extends a moving path along which the coupling protrusion 133 slides. By extending the moving path, it may be more difficult for the coupling protrusion 133 to be separated from the coupling groove 110′.

A coupling groove 110a of still another example embodiment shown in FIG. 8 includes the first groove rod 111 and the second groove rod 113 as in the above-described example embodiment, and further includes an escape prevention protrusion 115a.

The escape prevention protrusion 115a is formed on an inner surface of the second groove rod 113. The escape prevention protrusion 115a is formed on the inner surface of the second groove rod 113 at a position spaced apart by a predetermined distance from an end of the second groove rod 113 toward the first groove rod 111.

When the coupling protrusion 133 slides along the first groove rod 111 and the second groove rod 113, the coupling protrusion 133 is not easy to move to the end of the second groove rod 113 due to the escape prevention protrusion 115a. At this time, a user applies force to move the coupling protrusion 133 past the escape prevention protrusion 115 to the end of the second groove rod 113.

When the rack housing 10 and the bellows 30 are coupled in this way, an effect of escape prevention may be improved because the coupling protrusion 133 is unable to easily move towards the first groove rod 111 due to the escape prevention protrusion 115a.

The above description is merely illustrative of the technical spirit of the present disclosure, and various modifications and variations would be possible without departing from the essential characteristics of the present disclosure by those skilled in the art to which the present disclosure pertains.

Therefore, the example embodiments disclosed in the present disclosure are not intended to limit the technical spirit of the invention, but to explain it, and the scope of technical ideas of the invention is not limited by these example embodiments. The protection scope of the invention should be construed by the following claims, and all technical ideas within the scope equivalent thereto should be construed as being included in the scope of the invention.

REFERENCE NUMERALS

| | |
|---|---|
| 1: Electric power steering apparatus | 10: Rack housing |
| 30: Bellows | 50: Steel band |
| 100: Coupler | 110, 110′, 110a: Coupling groove |
| 111: First groove rod | 113: Second groove rod |
| 130: Protrusion member | 131: Ring band |
| 133: Coupling protrusion | 115: Third groove rod |
| 115a: Escape prevention protrusion | |

What is claimed is:

1. An electric power steering apparatus, comprising:
a rack housing extending in length along a lateral direction of a vehicle and opened by a hollow formed along its longitudinal direction to wrap a rack bar with both ends connected to tires, respectively;
bellows connected to both ends of the rack housing, respectively, and formed to be flexibly stretched or contracted in an axial direction;
a steel band provided to surround an end of the bellows connected to the rack housing to fix a connection of the rack housing and the bellows; and
a coupler provided at the both ends of the rack housing and the end of the bellows and configured to couple the rack housing and the bellows so that, when the rack housing and the bellows are connected, the bellows is not separated from the rack housing and maintained connected thereto.

2. The electric power steering apparatus of claim 1, wherein the coupler comprises:
a coupling groove concavely formed along a radial direction on an outer peripheral surface of an end of the rack housing; and
a protrusion member provided inside the end of the bellows and having a coupling protrusion inserted into the coupling groove to slide along the coupling groove.

3. The electric power steering apparatus of claim 2, wherein one coupling groove is provided or a plurality of the coupling grooves are provided to be spaced apart by a predetermined angle along a circumferential direction of the rack housing, and
when the plurality of coupling grooves are provided, a plurality of the coupling protrusions are provided to correspond to the plurality of coupling grooves.

4. The electric power steering apparatus of claim 2, wherein the coupling groove comprises:
a first groove rod formed to extend from the end of the rack housing in a direction parallel to an axial direction of the rack housing; and
a second groove rod formed to extend from an end of the first groove rod in a circumferential direction of the rack housing.

5. The electric power steering apparatus of claim 4, wherein the coupling groove further comprises a third groove rod extending from an end of the second groove rod in a direction parallel to the first groove rod toward the end of the rack housing, and formed to be shorter than a length of the first groove rod.

6. The electric power steering apparatus of claim 4, wherein the coupling groove further comprises an escape prevention protrusion formed on an inner surface of the second groove rod at a position spaced apart by a predetermined distance from an end of the second groove rod in a direction toward the first groove rod to prevent the coupling protrusion inserted to the end of the second groove rod form escaping.

7. The electric power steering apparatus of claim 2, wherein the protrusion member comprises a ring band having one surface in close contact with the inner surface of the end of the bellows, and formed in a circular ring shape so that the bellows communicates with the rack housing.

8. The electric power steering apparatus of claim 7, wherein one coupling protrusions is provided or a plurality of the coupling protrusions are provided to be spaced apart by a predetermined angle along a circumferential direction on an inner surface of the ring band.
